(19) United States
(12) Patent Application Publication
(10) Pub. No.: US 2005/0055309 A1
(43) Pub. Date: Mar. 10, 2005

(54) Method and apparatus for a one click upgrade for mobile applications

(75) Inventors: Chris Williams, Seattle, WA (US); David Parker, Seattle, WA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: Dwango North America, Houston, TX (US)

(21) Appl. No.: 10/744,865

(22) Filed: Dec. 23, 2003

Related U.S. Application Data
(60) Provisional application No. 60/500,108, filed on Sep. 4, 2003.

(51) Int. Cl. G06F 17/60

(52) U.S. Cl. 705/40

(57) ABSTRACT

The present invention enables a cell phone or PDA user to purchase a full version of an application with a single key stroke, without switching back and forth between the application and a browser. A one click upgrade is made available which is intuitive and quicker than prior methods known in the art. Trial versions in the present invention are full versions with most of the game disabled. Upgrades to the full version are enabled by setting a flag once the customer has paid for the upgrade. The customer is able to play one level or track for a game or to play the,game for limited period of time. Once the trial limit is reached, the content or game provider offers details on how to purchase the full version.

### CROSS REFERENCE TO RELATED APPLICATIONS

This patent application claims priority from U.S. Provisional Patent Application 60/500,108 Entitled, A Method and Apparatus for A One Click Upgrade for Mobile Gaming Applications, by David Parker, filed on Sep. 4, 2003, which is incorporated herein by reference in its entirety.

### BACKGROUND OF THE INVENTION

1. Field of the Invention

The present invention relates generally to the field of mobile gaming software or another application and in particular to the provision of a one click purchase, authentication or upgrade from a demonstration version to a full version of a game or other application while playing the game or using the application.

2. Summary of the Related Art

Typically, a user downloads a trial version of a game or other application from a carrier portal to a cell phone, personal data assistant (PDA) using Wireless Application Protocol (WAP) or another wireless or wired device capable of receiving a download from another device such as a server. Typically, the trial version has a limited life span or is a truncated version of the full levels or activities available on a full version of the game. The user plays the trial version of the game on his cell phone, PDA or another wireless or wired device capable of receiving a download from another device such as a server. If the user likes the game or application and wants to download the full version, he must exit the game or application and return to the carrier portal and purchase the game or application before he can request a download of the full version of the game or application. The download request is usually handled between the carrier portal and a billing server which authenticates the user and bills him for the game or application before allowing him to continue with the full version.

The demographic for PDA and cell phone or another wireless or wired device capable of receiving a download from another device such as a server for gaming is largely young and impatient. The fact that the user has to exit the game or application and take time to return to the carrier portal is undesirable. Once a user is in a game or application, the game provider wants to keep him there. Thus, there is a need for a method and apparatus that enables a user to upgrade a game or application on his cell phone or PDA or another wireless or wired device capable of receiving a download from another device such as a server without having to leave the game or application and return to the carrier portal.

### SUMMARY OF THE INVENTION

The present invention provides a method and apparatus that enables a user of a cell phone, PDA or another wireless or wired device capable of receiving a download from another device such as a server to purchase a full version of a game or other application with a single key stroke, without switching back and forth between the game or application and a browser. The present invention provides a more satisfying user experience which reduces customer chum. A one click upgrade is made available which is intuitive and quicker than prior methods known in the art. Wireless games and applications can be an impulse buy. The present invention makes the path to purchase wireless games or applications as simple as possible.

Free trial versions are an important component to the successful marketing of successful games and applications. Prior methods for upgrading from a trial version are tedious and cumbersome. In the present invention, trial versions are full versions but with most of the game or application disabled. Upgrades to the full version are enabled by setting a flag once the customer has paid for the upgrade. The customer may obtain a trial version by two methods, pre-loaded on a new phone or by downloading the trial version from WAP server or some other device. The customer is able to play one level or track of a trial game or application or to play the trial game or use the trial application for limited period of time. The content or game provider offers details on how to purchase the full version or the game or application within the main menu system for the game or application. Therefore, once the trial limit is reached the customer will both be aware of the method with which to upgrade and provided easy access to it.

### BRIEF DESCRIPTION OF THE FIGURES

For detailed understanding of the present invention, references should be made to the following detailed description of the preferred embodiment, taken in conjunction with the accompanying drawings, in which like elements have been given like numerals, wherein:

FIG. 1 is a hardware diagram showing client/server communication within the context of the present invention;

FIG. 2A is flow chart showing the execution of the present invention on the client side and on the server side;

FIGS. 2B-2E illustrate User Interface screens associated with the one-click upgrade process shown in FIG. 2A for the present invention; and

FIGS. 3-5 illustrate a more general User Interface specification for the present example of the invention.

### DETAILED DESCRIPTION OF AN EXEMPLARY EMBODIMENT

The present invention is useful in association with a cell phone, PDA or another wireless or wired device capable of receiving a download from another device such as a server. In this exemplary embodiment, the present invention is discussed as a cell phone or PDA, however, this is not intended to limit the application of the invention to only a cell phone or PDA, since, as stated, the present invention is also applicable to any other wireless or wired device capable of receiving a download from another device such as a server. The present example discusses a gaming application for illustrative purposes, however, the present invention is useful for other downloaded applications as well. Other downloaded trial applications could be a variety of applications, such as a catalog downloaded partially enabled or a shopping service partially enabled which are upgraded with the one-click upgrade of the present invention. In the past the typical user experience, when upgrading a game from a trial version to a full version proceeded as follows: 1) The user on a cell phone or PDA or another wireless or wired device capable of receiving a download from another device such as a server opened a carrier browser which consumed approximately 10 seconds with existing technology. 2) The user then surveyed a WAP Deck on his cell phone or PDA sent from a carrier. The WAP deck comprises a series of web pages that guides a user through various categories, for example, news, services, products, etc. 3) When a user chose “products” from the list of categories presented by the WAP deck, a new web page was presented on his cell phone or PDA which listed various categories of products, such as sports, travel, gaming, etc. 4) When a user chose a particular product, such as a game, the product web page screen was sent to his cell phone or PDA which displayed an offer for the game, for purchase of a full version or a trial version of the game.

Once a trial version game was selected, a trial version of the game was downloaded and installed as a trial application. The trial version of the game typically provided a subset of functions or a time limit in which the user could play the game. This download consumed from 10 to 30 seconds depending on the size of the game and the speed of the link between the content provider server and the client cell phone. The user then terminated the browser at the client and ran the game or application on his client cell phone or PDA.

Once the user decided to purchase a full version of the game and/or license it, the user exited the trial application and then uninstalled the trial application of the game from his cell phone or PDA. The user then opened the phone's browser again and navigated back through the WAP deck again to access the product screen for viewing the purchase option. This time the user selected the purchase option for the full version of the game. At this point the user contacted a billing server and waited for authentication and authorization. Once the billing server authorized the purchase and charged the client for the game, the full version of the game was downloaded. This consumed another 30 seconds to 1 minute, depending on the size of the game and the speed of the link between the content server and the client. This typical scenario was overly long, complex and tedious. Moreover, it required the user to exit the game! This is tantamount to changing the channel, something no content provider wants. It would have been preferable for the content provider to enable the user to upgrade the trial version into a full version without having to exit to access the WAP deck again to perform a second download to purchase the full version of the game.

The present invention provides a more satisfying user experience for purchasing a game or other application. The user incurs less overhead, less overall download time and less data entry than in the prior game trial/purchase scenario discussed above. In the present example of the invention, a full version of the game is downloaded when the user requests a trial version. However, the full version is disabled by a bit switch that disallows the functionality associated with the full version of the game. Thus the full version of the game, when disabled, performs like a trial version of the game. Thus when the user wants to purchase the game, the present invention enables the user to access the purchase option from within the game. This eliminates having to exit the game to access a carrier browser and perform another download, both actions consuming considerable time that could otherwise be spent gaming. Thus, the present invention reduces the risk of the prior art that the user will exit the application or game and not return. Once he exits, he may change his mind, since game purchases can be impulse buys and any extra distraction from the game/application and its purchase and brings with it a risk of losing the purchase of the game.

In the present example of the invention, a game player can enjoy playing a trial version of a game and select a purchase option from the game without having to exit the game to purchase an upgrade to a full version. In the present example of the invention, the game/content provider confirms pricing, processes payment and provides an unlock key to the game without an additional download. This is accomplished by enabling the game's bit switch to convert the trial version of the game to a fully operational version upon confirmation from the billing server that the purchase transaction was successful. This purchase scenario is much simpler and the process takes only 4-5 seconds. Moreover, the user experience is enhanced by the present invention and purchase transactions are not lost by forcing a user to exit the game and reenter the browser to purchase an upgrade.

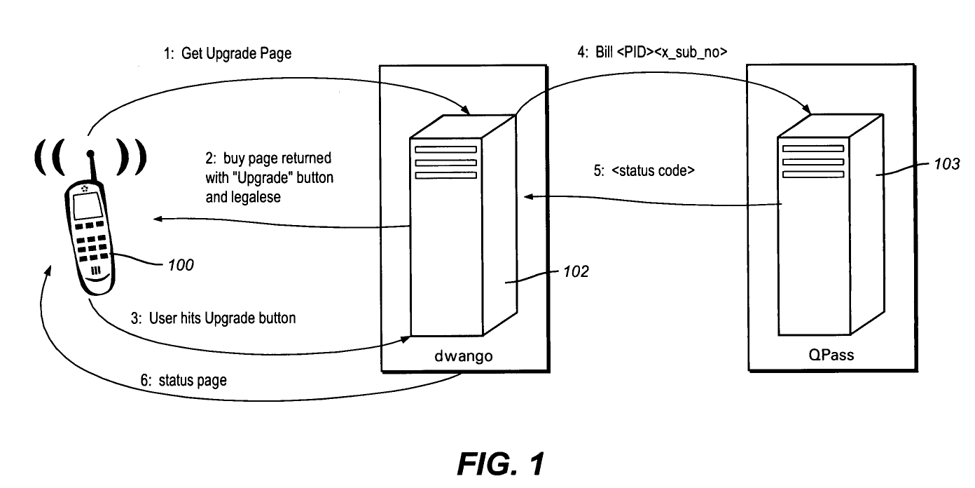

In the present example of the invention, a game player can enjoy playing a content provider 102 game as shown in FIG. 1. The Client Hardware 100 is comprised of a processor and memory for downloading data, and storing data persistently. An example of such as a client device is the NEC515 cell phone or any substantially compatible cell phone equipment. The client software comprises any upgradable (an application that offers trial and full versions along with the ability to upgrade from a trial version to a full version of the application from within it and without overwriting or uninstalling it) application capable of running on a mobile device with the above hardware specifications. One example of such an upgradable application is the Dwango North America game entitled “Star Diversion.”

In the client side of the invention, a client PDA or cell phone 100 interacts with a provider 102 as indicated by data stored in persistent memory on the cell phone or PDA. If the gaming application is a full version of the game, then the client application unlocks 206 all application restrictions and transforms the trial version into a full working version. The client application also no longer allows the ability to upgrade from a trial version of the game to full version. If the gaming application is a trial version of the game, then the client enforces all application restrictions of the game and enables upgrade functionality, 204. Upon activation of upgrade functionality on the client device by a user, the client application establishes a wireless connection with the content provider server system, and awaits a response 212.

Upon receipt of a response from the server, the client application parses the response for prior authorization 214. If not already authorized 218, the client application displays an error message 226 or informational/sales text 228 offering a purchase option for the full version of the game. If purchase is selected 220, the application returns 212 to contact the server. If purchase is not selected, the client application does nothing 222.

If authorized, the client displays a server-generated message informing the user he has successfully purchased or was already authorized from a previous transaction 224. Then the client application unlocks restricted sections of the game 230 stores authorization status in persistent memory, thus “flipping the bit,” and disabling application restrictions on the game.

In the present example of an embodiment of the present invention, a DoJa 1.5 application tests a single byte (referred to as “the bit”) in the application scratchpad on the client device, which stores the game status as a numeric value. (e.g., 0=trial, 1=full). This value is tested on application startup.

If the value of “the bit” indicates a full authorization, a Boolean value (isTrial) is set to false. The application code can test against this to determine which sections of code to enable. If the value of “the bit” indicates an unauthorized or trial version, the Boolean value (isTrial) is set to true. The application code can test against this to determine which sections of code to disable.

The application main menu displays an option to upgrade. Additionally, with the end of game play, this application displays sales text and an upgrade option. The application establishes a network connection with the content provider, e.g., the dwango server, using the standard http connection functionality provided by DoJa 1.5, and waits for a response from the server. The user is provided with animated UI that reads “Contacting Server . . . ” Upon receipt of a response from the gaming server, the client application parses the response for an authorization signature.

If not authorized, the client application displays informational/sales text and a purchase option to enable a user to buy the game. This text is returned to the application from the dwango server with the above response to enable dynamic content, such as price changes, etc. If authorized, the client application stores authorization status in the DoJa 1.5 scratchpad, and sets isTrial Boolean value to false.

On the server side, the server hardware comprises a file server 102 with dedicated high speed internet access and proper security settings, such as a Dell Poweredge 2550, 512 mb RAM, RAID 5 HD. The server software comprises an operating system, Web Application server, Encryption key, Connection and Encryption client code, and a Database. The server software for example, may comprise the following software components, a Windows 2000 Server, Apache Tomcat, Verisign v509 Certificate, Qpass Connection and Encryption Client, and MySQL server.

In the present example of the invention, the server side of the present invention operates as follows. A Purchase Service (PS) application on the server constantly awaits properly formatted purchase requests from qualified client devices.

Upon receipt 232 of such a request, PS parses the request header for customer identification data. The server performs a database query 234 in which PS extrapolates the product identification number that is attempting to be purchased from details contained within the request. PS builds a strictly formatted data structure containing vendor identifiers, product identifiers, and customer identifiers 236. PS opens a secure connection with the billing provider server utilizing the best practice encryption techniques.

The billing server processes the purchase request 240 and returns a transaction status code to the content server 250. PS transmits data structure to billing provider and awaits response 238. Upon receipt of a response from billing server, PS parses it for transaction status code. The content provider server identifies the transaction code, and stores transaction details in the database 248.

PS compares a status code against a list of known results and generates a status message and authorization key if a “successful” status code was returned from billing server 246. PS returns a status message and an authorization key if status is “permitted” or an error code if status is “not permitted” 242 to the client application running on handset. Specifically, in the present example of the invention, the dwango purchaseApp (DPA) constantly awaits a properly formatted purchase request from qualified devices. Upon receipt of a purchase request, DPA parses the http request header associated with the purchase request for an x-up-subno field. This value is unique for each customer and sets the subno variable. DPA reads the “product” request parameter in order to establish which product to bill for and sets the product id variable.

DPA builds an XML structure identifying itself as the vendor, and specifying which product (product_id) is being sold to which customer (subno). This is done by using Java's Document Object Model. DPA opens a secure connection with the billing provider server utilizing the Connectivity and Encryption client provided by the billing provider. DPA transmits XML structure to a billing provider and awaits a response. Upon receipt of a response from the billing server, DPA parses the response for a transaction status code. DPA stores a record of transaction in the Database. The record comprises Customer ID, Product ID, Status Code and a Timestamp.

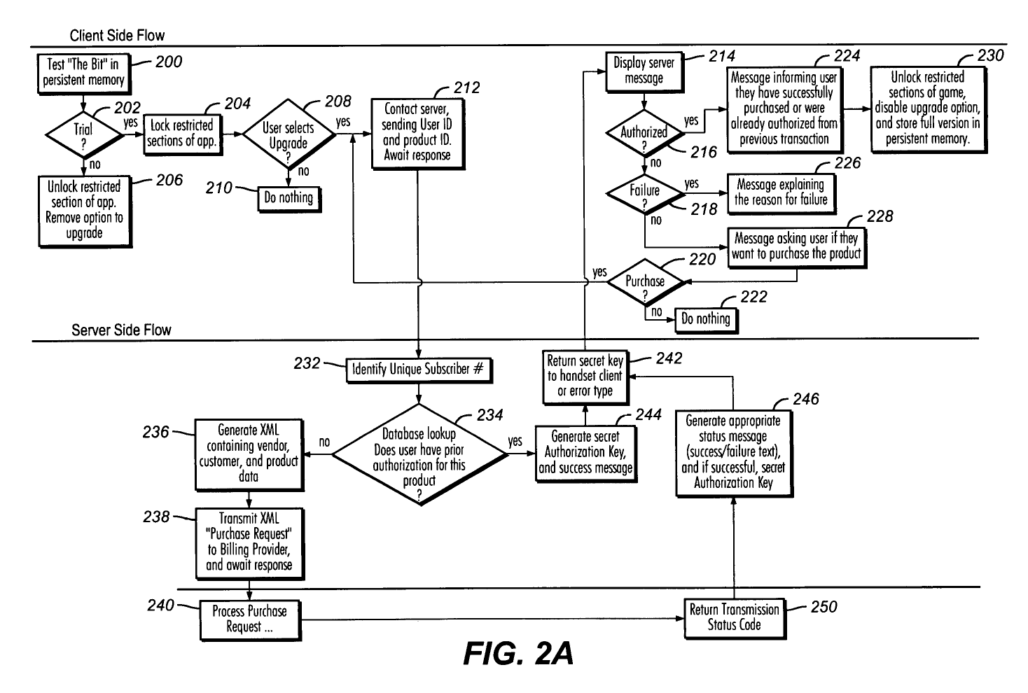

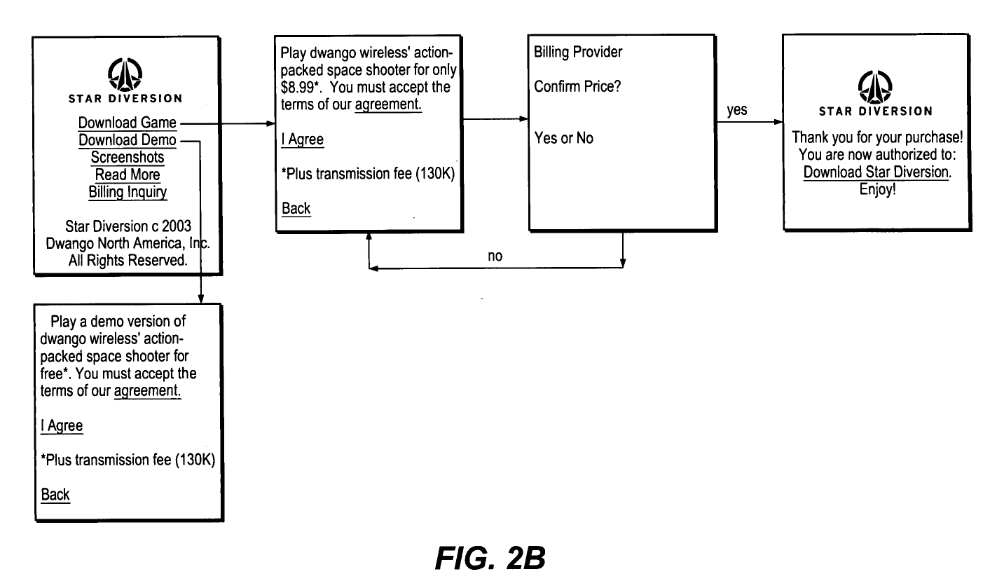

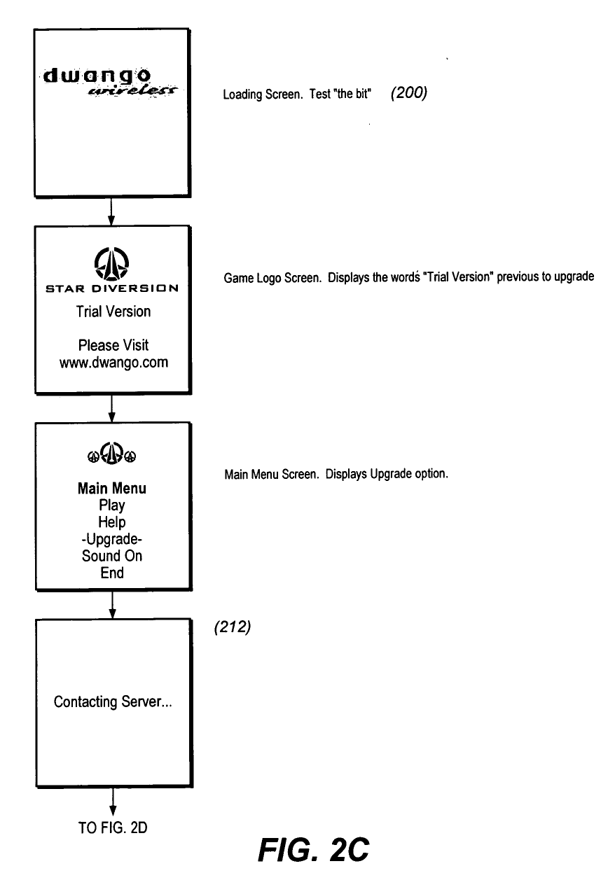

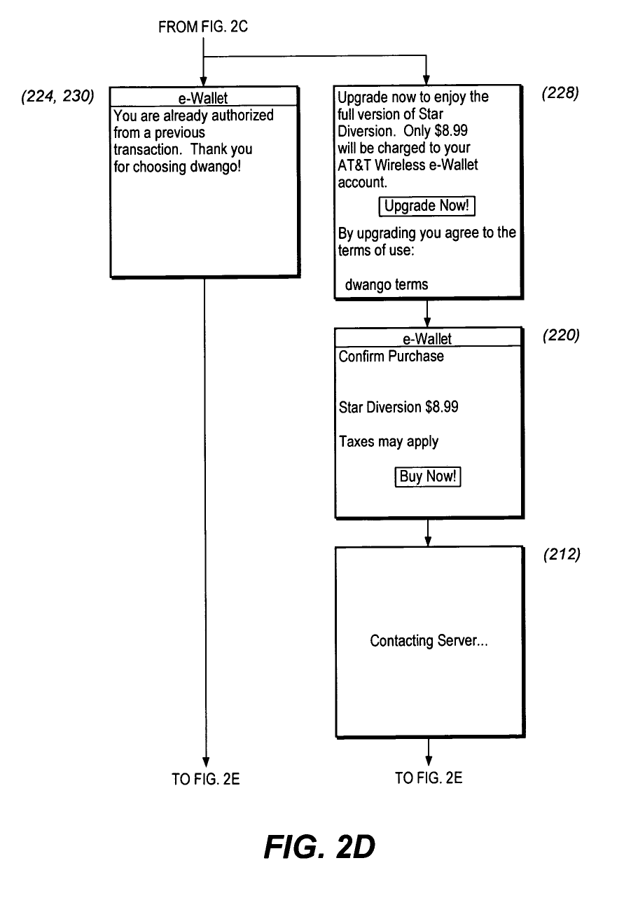

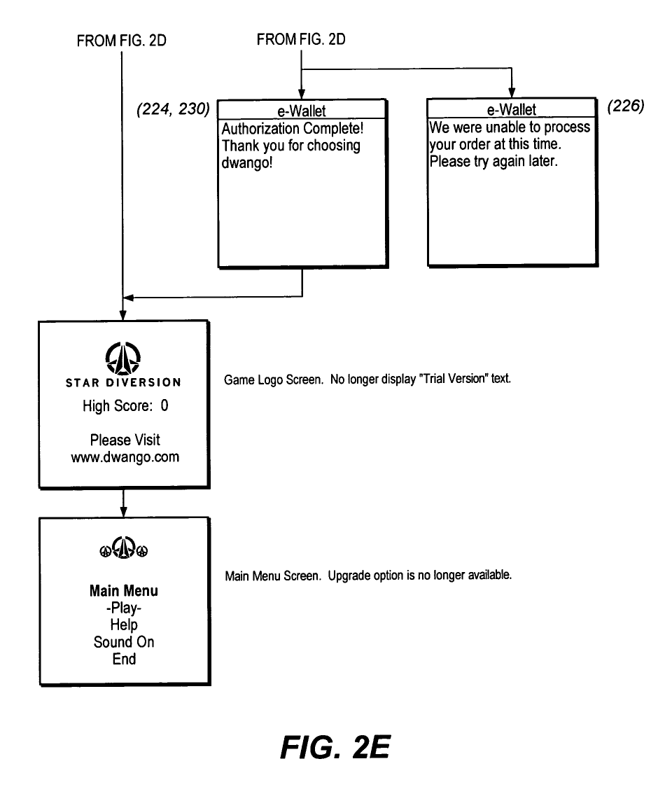

DPA compares status code against list of known results and generates status message and authorization key if “successful” status code was returned from billing server. DPA returns status message and authorization key if permitted to client application running on handset. FIGS. 2B-2E show actual example screens associated with like numbered steps in FIG. 2A.

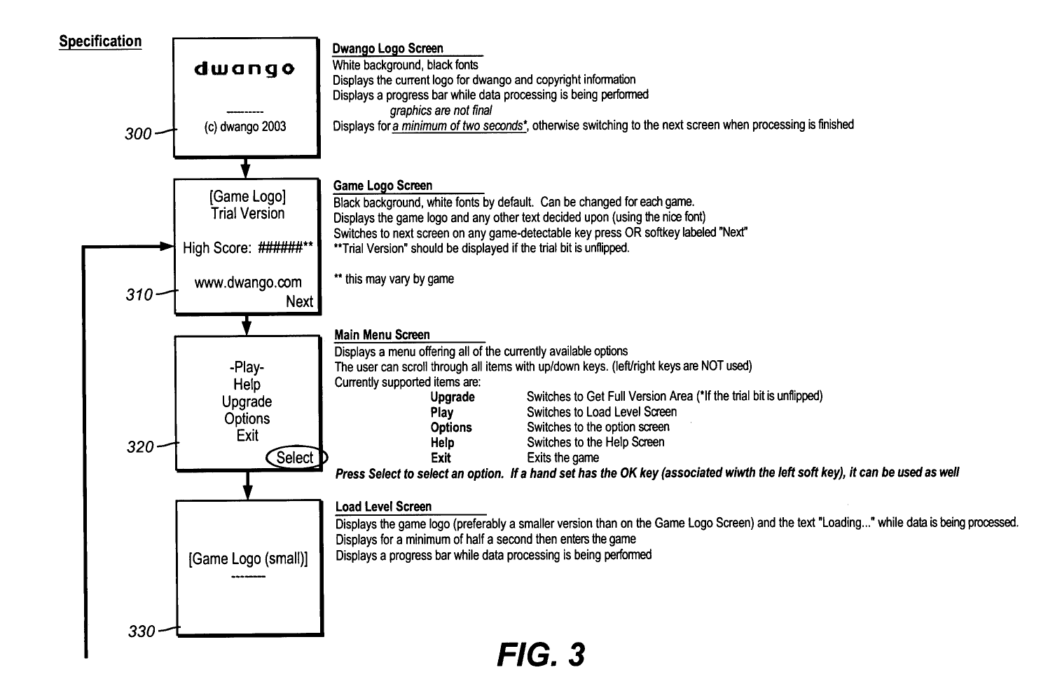

Turning now to FIGS. 3-5, a general UI specification for the present example of the invention is shown. The content provider briefly displays a content provider logo screen 300 when a game is requested. A game logo screen is then displayed to the user 310. A trial version is indicated if the trial bit is un-flipped. A main menu screen is provided to display a menu offering all of the currently available options for the game. In the present example a user can select Upgrade, Play, Options, Help or Exit.

In the current example of the invention a load level screen is displayed showing a game logo 330. A message indicating that the game is loading is displayed while data is being processed and a progress bar is displayed while data processing is being performed.

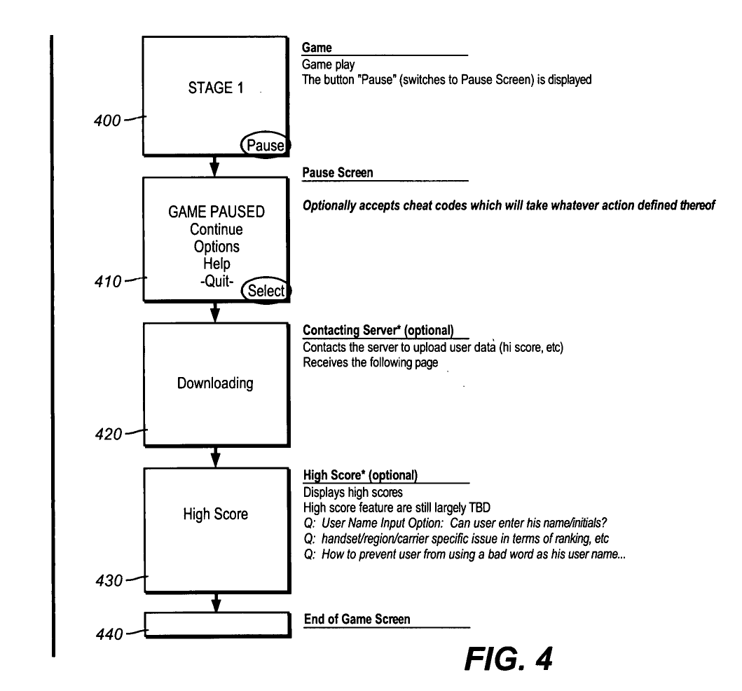

Turning now to FIG. 4, game play is provided at this point 400. A pause screen is provided as an option when pause selected 410. The pause optionally accepts cheat codes which will take whatever action is defined by the cheat codes. The content server optionally provides user data such as high score, etc. 420. A high score screen 430 is displayed when selected. Users names are entered and censored for inappropriate content such as profane language 430. An end game screen is provided at the end of the game or upon termination by the user 440.

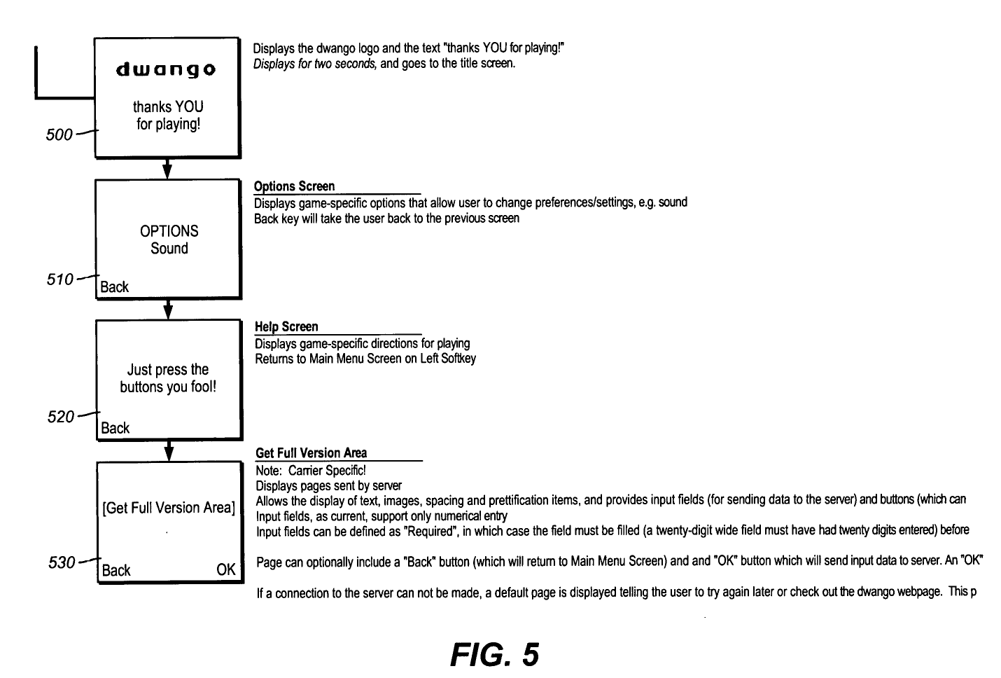

Turning now to FIG. 5, after ending the game a content provider screen is provided and thanks the user for playing and may present additional offers 500. An options screen 510 is provided which displays game-specific options that allow a user to change preferences/settings, e.g., sound. A back key takes the user back to the previous screen. A help screen is provided 520 that displays game-specific directions for playing. A get full version screen is presented 530 after playing a demonstration version of the game.

In another embodiment, the method of the present invention is implemented as a set computer executable of instructions on a computer readable medium, comprising ROM, RAM, CD ROM, Flash or any other computer readable medium, now known or unknown that when executed cause a computer to implement the method of the present invention.

While the foregoing disclosure is directed to the preferred embodiments of the invention various modifications will be apparent to those skilled in the art. It is intended that all variations within the scope of the appended claims be embraced by the foregoing disclosure. Examples of the more important features of the invention have been summarized rather broadly in order that the detailed description thereof that follows may be better understood, and in order that the contributions to the art may be appreciated. There are, of course, additional features of the invention that will be described hereinafter and which will form the subject of the claims appended hereto.

1. A method for upgrading an application on a mobile device comprising:
downloading to a mobile device a full version of an application with restrictions on the operations the application can perform;
accepting an application purchase command from the mobile device while the user is in the application; and
removing the restrictions on the game so that the application can perform more operations.

2. The method of claim 1, further comprising:
authorizing billing for the application purchase in response to the application purchase command.

3. The method of claim 1, further comprising:
accepting the application purchase command at the content provider.

4. The method of claim 2, further comprising:
authorizing billing for the application at the content provider.

5. The method of claim 4, further comprising:
sending a request from the content provider to a billing server to authorize billing.

6. A computer readable medium containing instructions, that when executed by a computer performs a method for upgrading an application on a mobile device comprising:
downloading to a mobile device a full version of an application with restrictions on the operations the application can perform;
accepting an application purchase command from the mobile device while the user is in the application; and
removing the restrictions on the application so that the application can perform more operations.

7. The medium of claim 6, further comprising:
authorizing billing for the application purchase in response to the application purchase command.

8. The medium of claim 6, further comprising:
accepting the application purchase command at the content provider.

9. The medium of claim 7, further comprising:
authorizing billing for the application at the content provider.

10. The medium of claim 9, further comprising:
sending a request from the content provider to a billing server to authorize billing.

11. An apparatus for upgrading an application on a mobile device comprising:
a function for downloading to a mobile device a full version of an application with restrictions on the operations the game can perform;
a function for accepting an application purchase command from the mobile device while the user is in the application; and
a function for removing the restrictions on the application so that the application can perform more operations.

12. The apparatus of claim 11, further comprising:
a function for authorizing billing for the application purchase in response to the game purchase command.

13. The apparatus of claim 1, further comprising:
a function for accepting the application purchase command at the content provider.

14. The apparatus of claim 12, further comprising:
a function for authorizing billing for the application at the content provider.

15. The apparatus of claim 14, further comprising:
sending a request from the content provider to a billing server to authorize billing.
